(19) United States
(12) Patent Application Publication
(10) Pub. No.: US 2025/0286080 A1
(43) Pub. Date: Sep. 11, 2025

(54) SCAFFOLDED CURRENT COLLECTOR FOR METAL ANODE, METHOD OF MAKING, AND BATTERY USING

(71) Applicant: BATTELLE MEMORIAL INSTITUTE, Richland, WA (US)

(72) Inventors: WU XU, Richland, WA (US); HAO JIA, Richland, WA (US); JIGUANG ZHANG, Richland, WA (US); JU-MYUNG KIM, Richland, WA (US)

(73) Assignee: BATTELLE MEMORIAL INSTITUTE, Richland, WA (US)

(21) Appl. No.: 19/020,827

(22) Filed: Jan. 14, 2025

Related U.S. Application Data
(60) Provisional application No. 63/621,051, filed on Jan. 15, 2024.

(51) Int. Cl. H01M 4/80; C23C 18/16; C23C 18/38; D04H 1/4326; D04H 1/4382; D04H 1/728; D06M 11/83; D06M 101/30; H01M 4/04; H01M 4/66; H01M 10/0525; H01M 10/054

(52) U.S. Cl. CPC H01M 4/806; C23C 18/1641; C23C 18/1692; C23C 18/38; D04H 1/4326; D04H 1/43838; D04H 1/728; D06M 11/83; H01M 4/0404; H01M 4/661; H01M 4/667; H01M 4/668; H01M 10/0525; H01M 10/054; D06M 2101/30; D10B 2331/14; D10B 2505/00

(57) ABSTRACT

Embodiments provide metal batteries (e.g., lithium metal batteries), scaffolded collectors for anodes for such batteries, and methods for making such scaffolded collectors. One formation method includes electrospinning a polymeric material (e.g., polyimide) to form a nanomat, matrix or scaffold with opening or voids therein. The scaffold is treated to incorporate potassium ions which are then replaced by silver ions, which are then converted to silver seeds. The seeded scaffold receives copper via electroplating which is then followed by heat-treating to make the copper smooth and uniform. Openings within the heat-treated copper coated scaffold can then be loaded with anode material (e.g., lithium) and used as part of a metal battery. The copper coated scaffold without additional loading can also be used as current collector in anode-free metal batteries.

### RELATED APPLICATIONS

This application claims benefit of U.S. Patent Application No. 63/621,051 filed Jan. 15, 2024. This referenced application is hereby incorporated herein by reference in its entirety including appendices and items incorporated therein by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

The invention generally relates to metal batteries (e.g., lithium (Li) metal batteries (LMBs)) and more particularly to methods for forming current collectors for supporting metal anodes (e.g., Li metal anodes (LMAs)), and even more particularly to methods of forming current collectors including a porous dielectric scaffolding, nanomat, or matrix material that supports a substantially conformal conductive path coating or layer (e.g., copper (Cu)) such that voids are provided between coated scaffolding fibers into which metal anode material (e.g., Li) can be loaded. The invention also relates to current collectors formed by such methods and batteries using such current collectors.

### Background Information

Practical applications of high energy density rechargeable LMBs have been impeded by the intrinsic issues associated with LMAs including high reactivity of Li metal with electrolyte and dendritic formation of Li. Conventional LMAs consist of a Li layer on a two-dimensional Cu foil. These current collectors lead to loss in specific energy density since Cu is a heavy metal and provides excess weight. These current collectors also result in loss of areal capacity due to the “hostless” feature of LMA which causes the limitation of Li utilization and volume expansion. Furthermore, these featureless, or hostless, Li support structures provide no inherent volume retaining three-dimensional (3D) framework for supporting significant quantities of anode metal in a manner that maintains access to useable anode metal and provides a framework that reduces volume expansion and contraction upon repeated loading and unloading the collector with anode metal.

A need exists for an improved method of making current collectors for anodes, improved current collectors for anodes that provide reduced volume change during charging and discharging, improved access to useable Li after repeated charging and discharging of batteries, and improved battery life.

### SUMMARY

To address the above noted problems, a 3D polymeric scaffold with a thin conductive coating was designed and fabricated for use as a current collector. In one implementation, the current collector includes a heat-treated, 3D-structured, Cu-coated polyimide (PI), i.e. HT-Cu@PI scaffold. This HT-Cu@PI scaffold current collector enables a more uniform morphology of electrochemically deposited Li (EDLi) to provide a more uniform/continuous Li-ion transport pathway. It also leads to a significant increase in the gravimetric/volumetric energy densities of LMBs by allowing more Li deposition in a fixed weight/volume of LMAs.

In some embodiments of the invention a method of manufacturing current collectors and more specifically a current collector for a metal anode is provided. In one such embodiment, for example, electrospinning is used to form a thin polymeric nanomat or scaffold. The polymeric scaffold, in this example, is formed from PI and is seeded with potassium (K) ions, the K ions are thereafter replaced with silver (Ag) ions, and the Ag ions are thereafter replaced with Ag atoms to provide Ag nanostructures, and finally the Ag seeded polymeric scaffold is electroless plated with Cu that is thereafter made more uniform, more continuous, and/or smoother via heat treatment that is applied for a selected time and temperature that does not result in excessive damage to the polymeric scaffold (i.e. damage that would make the polymeric structure incapable of performing its intended function) while still providing a surface that is more conducive to loading and discharging metal anode material (e.g. LMA material).

In some embodiments of the invention, an improved current collector, and more particularly an improved current collector for an anode is provided. For example, such an improved anode may include a polymeric scaffold structure such as PI that includes seed areas of a first metal, such as Ag, that are overcoated with a second metal, such as Cu that is capable of undergoing electrochemically loading and releasing of an anode metal, such as Li, on a cyclical basis during operation as part of a rechargeable battery.

In some embodiments of the invention, an improved metal battery uses an improved current collector of the type set forth herein. In some embodiments the improved battery may be an anode-free battery where the battery as manufactured lacks an active anode material but includes an anode current collector wherein the anode is created during an initial charging process

In a first aspect of the invention a method of forming a current collector for a metal anode, includes: (a) providing an electrospun dielectric polymer scaffold formed from crossed strands of polymer with openings between strands of the polymer; (b) etching the scaffold to introduce K ions; (c) replacing the K ions with Ag ions; (d) modifying the scaffold to replace Ag ions with Ag nanoparticles; (e) depositing Cu onto the scaffold having the Ag nanoparticles while maintaining openings between the strands; and (f) heat-treating the Cu plated scaffold at a selected temperature and time that is effective in reducing roughness of deposited Cu while not excessively damaging the polymer scaffolding to yield a polymer structure with openings between the coated strands that is more capable of repeatedly receiving and holding a metal anode material within its openings and discharging such metal anode material than it would have been without the heat treatment.

Numerous variations of the first aspect of the invention exist and include, for example: (1) the first aspect additionally including embedding the active anode metal into the openings in the Cu coated, heat treated, dielectric polymer scaffold to form an anode for a metal battery; (2) the first variation of the first aspect wherein the active anode metal includes Li; (3) the first aspect or any of its first to second variations wherein the polymer includes PI (i.e., the polymer is made of PI alone or in combination with one or more other materials), (4) the first aspect or any of its first to third variations wherein the polymer is selected from the group of (a) PI, (b) polycarbonate, (c) polysulfone, and (d) a combination of two or more of the polymers of (a)-(c); (5) the first aspect or any of its first to four variations wherein the scaffold has an area and has a nominal thickness for at least a portion of the area, wherein the nominal thickness is selected from the group of (a) between 1 and 100 microns (μm) inclusive, (b) between 5 and 50 μm inclusive, and/or (c) between 10-30 μm inclusive; (6) the fifth variation of the first aspect wherein the portion of the area is selected from the group of (a) at least 50% of the area, (b) at least 70% of the area, (c) at least 90% of the area, and (d) at least 99% of the area; (7) the first aspect or any of its first to sixth variations wherein the majority of the strands of the polymer have nominal diameters selected from the group of (a) between 0.1 μm to 10 μm and/or (b) 0.5 μm and 2 μm; (8) the majority of the strands of the seventh variation of the first aspect being selected from the group of (a) at least 70% of the strands, (b) at least 90% of the strands, and/or (c) at least 99% of the strands; and (9) the first aspect or any of its first to eighth variations wherein a majority of the openings between the strands have a width and length in a plane perpendicular to a thickness of the scaffold that are nominally in the range of 1 to 5 times a diameter of the strands.

Additional variations include, for example: (10) the eleventh variation of the first aspect wherein the majority of the openings of the tenth variation are selected from the group of (a) at least 70% of the openings, (b) at least 90% of the openings, and/or (c) at least 99% of the openings; (11) the first aspect or any of its first to tenth variations wherein the etching includes the use of a solution of potassium hydroxide (KOH) in ethanol; (12) the first aspect or any of its first to eleventh variations wherein the replacing includes immersing the scaffold in a solution of silver nitrate; (13) the first aspect or any of its first to twelfth variations wherein the modifying including use of an aqueous solution; (14) the first aspect or any of its first to thirteenth variations wherein the depositing includes electrolessly depositing Cu; (15) the first aspect or any of its first to fourteenth variations wherein the Cu has a nominal thickness selected from the group of (a) between 1 and 1000 nanometers (nm) inclusive, (b) 5-200 nm inclusive, and/or (c) between 10-100 nm inclusive; (16) the first aspect or any of its first to fifteenth variations wherein the heat-treating includes exposing the scaffold for a time period of at least one hour to a temperature selected from the group of (a) between 100° C. to 300° C., (b) between 150° C. to 250° C., and (c) between 175° C. to 225° C.; (17) the sixteenth variation of the first aspect wherein the time period is selected from the group of (a) at least 2 hours, (b) at least 4 hours, and (c) at least 8 hours; (18) any of the first to seventeenth variations of the first aspect of the invention wherein the receiving of metal includes electrochemical deposition of the metal; and (19) any of the first-seventeenth variation of the first aspect of the invention wherein the receiving of the metal includes applying molten metal to the scaffold to at least partially fill openings in the scaffold.

In a second aspect of the invention a current collector for a metal anode is provided that includes: (a) a nonwoven polymeric scaffold comprising strands of dielectric polymer with each strand having a surface and wherein the scaffold has openings located between the strands; (b) metal nanoparticle material seeds located on the surfaces of the strands of the scaffold, and (c) Cu overcoating the metal nanoparticle material seeds to define a copper coated scaffold wherein the Cu provides a continuous conductive surface over the surface of the metal seeded scaffold and wherein openings remain between the Cu coated strands for receiving an anode metal.

Numerous variations of the collector of the second aspect of the invention are possible and include for example: (1) an anode metal at least partially filling the openings of the scaffold; (2) the second aspect or its first variation wherein the anode metal includes Li, (3) the second aspect or its first or second variations wherein the polymer includes a polymer selected from the group of (a) PI, (b) polycarbonate, and (c) polysulfone; (4) the second aspect or any of its first to third variations wherein the scaffold has a nominal thickness for at least part of its area of (a) between 1 μm and 100 μm, (b) between 5-50 μm, and/or (c) between 10-30 μm; (5) the second aspect or any of its first to fourth variations wherein a majority of the strands of the polymer have nominal diameters selected from the group of (a) between 0.1 μm and 10 μm, and (b) 0.5 μm and 2 μm; (6) the second aspect or any of its first to fifth variations wherein the nanoparticle seed material includes silver; and (7) the second aspect or any of its first to sixth variations wherein the copper has a nominal thickness selected from the group of (a) between 1 and 1000 nm, (b) between 5 and 200 nm, and (c) between 10 and 100 nm.

In a third aspect of the invention, a metal battery includes: (a) a scaffolded current collector for an anode comprising a nanomat of polymeric dielectric strands seeded with a first metal and covered with a second metal, wherein openings are located between the coated strands, wherein an anode metal is located at least partially into the openings, and wherein the second metal is different from the first metal and is also different from the anode metal; (b) a cathode including a current collector; (c) an electrolyte for conducting ions between the anode and the cathode; (d) a separator located between the anode and the cathode; and (e) a case for holding the anode, the cathode, the electrolyte, and the separator.

Numerous variations of the third aspect of the invention are possible and include for example: (1) the metal anode material including Li and the metal battery being an LMB; (2) the third aspect or its first variation wherein the polymeric material includes a material selected from the group of (a) PI, (b) polycarbonate, and (c) polysulfone; (3) the third aspect or either of its first or second variations wherein the scaffold has a nominal thickness for at least part of its area that is selected from the group of (a) between 1 μm and 100 μm, (b) between 5-50 μm, and/or (c) between 10-30 μm; (4) the third aspect or any of its first to third variations wherein a majority of the strands of the polymer have nominal diameters selected from the group of (a) between 0.1 μm and 10 μm, and (b) between 0.5 μm and 2 μm; and (5) the third aspect or any of its first to fourth variations wherein the second metal includes copper and has nominal thickness selected from the group of (a) between 1 and 1000 nm, (b) between 5-200 nm, and/or (c) between 10-100 nm.

In a fourth aspect of the invention, an anode-free metal battery, includes: (a) a scaffolded anode current collector for an anode comprising a nanomat of polymeric dielectric strands seeded with a first metal and covered with a second metal, wherein openings are located between the covered strands, and wherein the second metal is different from the first metal; (b) a cathode including a current collector; (c) an electrolyte for conducting metal ions between the scaffolded anode current collector and the cathode; (d) a separator located between the cathode and the anode current collector; and (e) a case for holding the cathode, the anode current collector, the separator, and the electrolyte.

Numerous variations of the fourth aspect are possible and include, for example: (1) the cathode including active ions of a metal selected from the group of: (A) Li, (B) sodium (Na), and (C) K which provide functionality selected respectively from the group of: (A) anode-free LMB functionality, (B) anode-free Na metal battery functionality and (C) anode-free K metal battery functionality; (2) the third aspect or the first variation of the third aspect wherein the polymeric material comprises a polymer selected from the group of: (a) PI, (b) polycarbonate, and (c) polysulfone; (3) the third aspect or either of its first or second variations wherein the scaffold has a nominal thickness for at least part of its area selected from the group of: (A) between 1 μm and 100 μm, (B) between 5-50 μm, and (C) between 10-30 μm; (4) the third aspect or any or its first to third variations wherein a majority of the strands of the polymer have nominal diameters selected from the group of: (A) between 0.1 μm and 10 μm, and (B) between 0.5 μm and 2 μm; and (5) the third aspect or any of its first to fourth variations wherein the second metal comprises copper and has nominal thickness selected from a group of: (A) between 1 and 1000 nm, (B) between 5-200 nm, and (C) between 10-100 nm.

Other objects and advantages of various aspects and embodiments of the invention will be apparent to those of skill in the art upon review of the teachings herein. The various aspects and embodiments of the invention, set forth explicitly herein or otherwise ascertained from the teachings herein, may address any one of the above objects alone or in combination, or alternatively may address some other object of the invention ascertained from the teachings herein. It is not intended that any specific aspect or embodiment of the invention (that is explicitly set forth herein or that is ascertained from the teachings herein) necessarily address any of the objects set forth above let alone address all these objects, but some aspects and embodiments may address more than one of these objects simultaneously.

Various advantages and novel features of the present invention are described herein and will become even more apparent to those skilled in this art from the following detailed description. In the preceding and following descriptions a preferred embodiment of the invention is set forth by way of illustration of the best mode contemplated for carrying out the invention. As will be apparent to those of skill in the art after reviewing the disclosure set forth herein, embodiments of the invention are capable of modification in various respects without departing from the spirit of invention. Accordingly, the drawings and description of the embodiments set forth hereafter are to be regarded as illustrative in nature, and not as restrictive.

### BRIEF DESCRIPTION OF THE DRAWINGS

FIG. 1 provides block diagram of a process embodiment of the invention that includes providing a copper coated dielectric polymeric scaffold formed of nanofibers (e.g., PI nanofibers), loading anode metal into openings in the polymeric structure, and then assembling the created anode current collector with other components to form a rechargeable metal battery (e.g., an LMB).

FIG. 2 provides a block diagram of an embodiment of the invention that provides a specific process for creating the Cu coated scaffold of the first block of FIG. 1.

FIG. 3 provides a block diagram that provides a specific process for attaching the seed material to the polymeric scaffold of the second block of FIG. 2.

FIGS. 4A-4D illustrate five steps in a specific process of forming a preliminary or initial Cu coated PI scaffold structure.

FIGS. 4E1, 4E2, and 4E3 provide images showing the morphology of Cu@PI by scanning electron microscopy (SEM) with energy dispersive X-ray spectroscopy (EDS) mapping.

FIG. 5A provides an SEM image of a Cu coating on the nanomat that has not been subjected to heat treatment while FIGS. 5B-5F provide SEM images of Cu coated scaffolds that were subject to different heat treatment processes.

FIGS. 6A-6F provide several side view SEM images of an anode material (Li in this example) loaded onto a Cu coated polymeric scaffold (PI in this example) where the Cu coated scaffolding has been exposed to different heat treatments prior to Li loading wherein different levels of Li penetration into scaffold openings, voids, or pores can be seen.

FIG. 7 provides bar charts showing the areal mass of Cu versus deposited Li associated with a Bare Cu substrate and with an HT-Cu@PI scaffold.

FIGS. 8A and 8B provide graphs illustrating the improvement in discharge rate capability (FIG. 8A) and long-term cyclability of a battery (FIG. 8B) formed with the heat-treated Cu coated PI collector of an embodiment of the present invention compared to that of a battery having a bare copper collector.

FIG. 8C provides bar charts of the specific energy for an EDLi-Bare Cu||NMC822 cell stake and an EDLi-HT-Cu@PI ||NMC822 cell stake at a first cycle and at a 180th cycle illustrating the improvement in specific energy initially and after long cycling provided by the HT-Cu@PI anode current collector.

FIG. 8D provides energy density plots for an EDLi-Bare Cu||NMC822 cell stake and an EDLi-HT-Cu@PI ||NMC822 cell stake at a first cycle and at a 180th cycle illustrating the improvement in energy density after long cycling provided by the HT-Cu@PI anode current collector.

FIGS. 9A1-9B3 provide schematic illustrations comparing Li ion transfer, formation of SEI layer on Li metal, and volume expansion of Li metal between a cathode and a Cu foil current collector for an anode of the prior art (FIG. 9A1-9A3) and between a cathode and a heat-treated Cu coated dielectric scaffold current collector for an anode of an embodiment of the present invention (FIGS. 9B1-9B3).

### DETAILED DESCRIPTION OF EMBODIMENTS OF THE INVENTION

The following description includes specific embodiments including the preferred best mode of the present invention. It will be clear from this description that the invention is not limited to these illustrated embodiments. Therefore, the present description should be seen as illustrative and not limiting. While the invention is susceptible of various modifications and alternative constructions, it should be understood, that there is no intention to limit the invention to the specific forms disclosed, but, on the contrary, the invention is to cover all modifications, alternative constructions, operations, and equivalents falling within the spirit and scope of the invention as defined in the claims.

### Definitions

As used herein, the following terms, acronyms, and phrases have the following meanings.
LMA: Lithium metal anode,
PI: polyimide,
CEI: cathode-electrolyte interphase,
SEI: solid electrolyte interphase,
EDLi: electrochemically deposited Li,
HT: Heat treated,
Cu@PI: Cu coated PI, and
SEM: scanning electron microscope.

### Embodiments

FIG. 1 provides block diagram 100 of an embodiment of the invention that includes providing a Cu coated dielectric polymeric scaffold formed of nanofibers (e.g., PI nanofibers), loading anode metal into openings in the polymeric structure, and then assembling the created anode/collector with other components to form a rechargeable metal (e.g., Li) battery. Block 101 calls for the creating or otherwise providing a Cu coated nanomat, matrix, or scaffold (hereafter “scaffold”) of joined dielectric nanofibers (e.g., PI) having openings, voids, or pores between the Cu coated nanofibers of appropriate size that allow effective loading with anode material in a subsequent operation. Block 111 calls for loading the openings in the coated scaffold with an anode material (e.g., Li via electroplating) to form a metal battery anode consisting of the active anode material (e.g., Li) loaded on a current collector (Cu coated nanomat or scaffold). Block 121 calls for assembling the loaded current collector with other battery components to form a rechargeable battery. The additional battery components may include, for example, a multi-piece casing, an insulator to seal and electrically separate battery terminals, a cathode including a current collector, an electrolyte, and potentially a separator (particularly when the electrolyte is a liquid). Some batteries may lack one or more of these components while other batteries may include additional components.

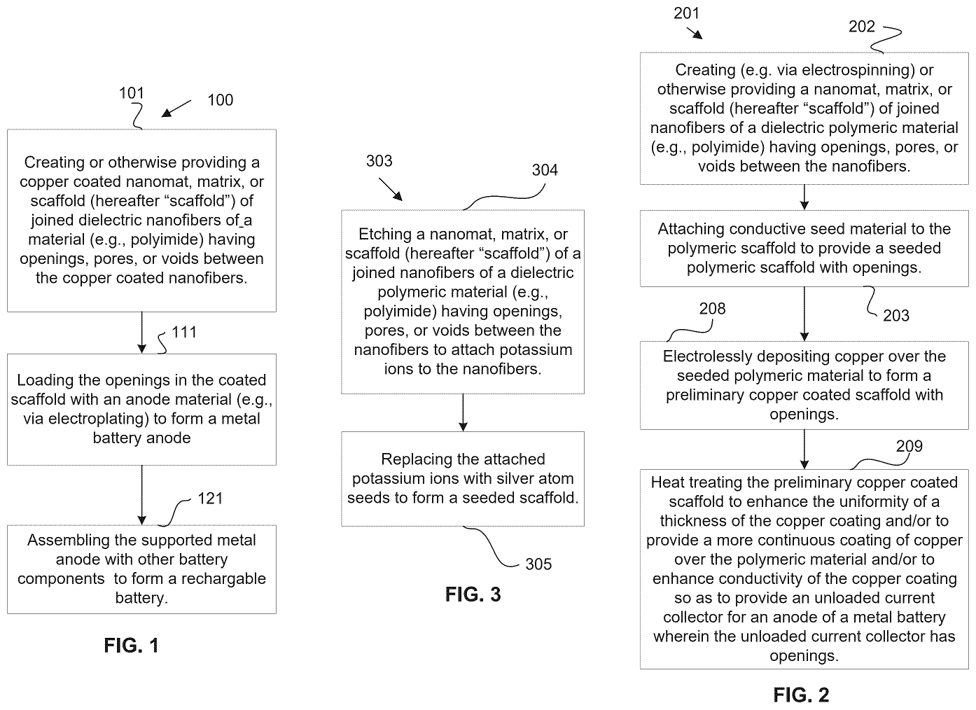

FIG. 2 provides a block diagram 201 of an embodiment of the invention that provides a specific process for creating the Cu coated scaffold of the block 101 of FIG. 1. In particular, the diagram 201 begins with block 202 which calls for creating (e.g., via electrospinning) or otherwise providing a nanomat, matrix, or scaffold (hereafter “scaffold”) of joined nanofibers of a dielectric polymeric material (e.g., PI) having openings between the nanofibers. Next, the process moves to block 203 which calls for attaching conductive seed material to the polymeric scaffold to provide a seeded polymeric scaffold having openings. Next the process moves to block 208 which calls for electrolessly depositing Cu over the seeded polymeric material to form a preliminary Cu coated scaffold that continues to have openings, pores, or voids. Next the process moves to block 209 which calls for heat-treating the preliminary Cu coated scaffold to enhance the uniformity of a thickness of the Cu coating, to provide a more continuous and smooth coating of Cu over the polymeric material, and/or to enhance conductivity of the Cu coating so as to provide an unloaded current collector for an anode of a metal battery wherein the unloaded current collector has openings, pores, or voids that are capable of receiving anode metal.

FIG. 3 provides a block diagram 303 that provides a specific process for implementing the attaching process of block 203 of FIG. 2. Diagram 303 starts with Block 304 which calls for the etching of the nanomat, matrix, or scaffold (hereafter “scaffold”) of joined nanofibers of a dielectric polymeric material (e.g., PI) to attach K ions to the nanofibers. The etching may be performed using KOH. After the etching, the process moves forward to block 305 which calls for the replacing the attached K ions with Ag nanoparticle seeds to form a seeded scaffold.

In some alternative embodiments, to the process of FIG. 3, it is believed that the potassium ions may be replaced with Na ions or Li ions, for example via use of sodium hydroxide (NaOH) or lithium hydroxide (LiOH).

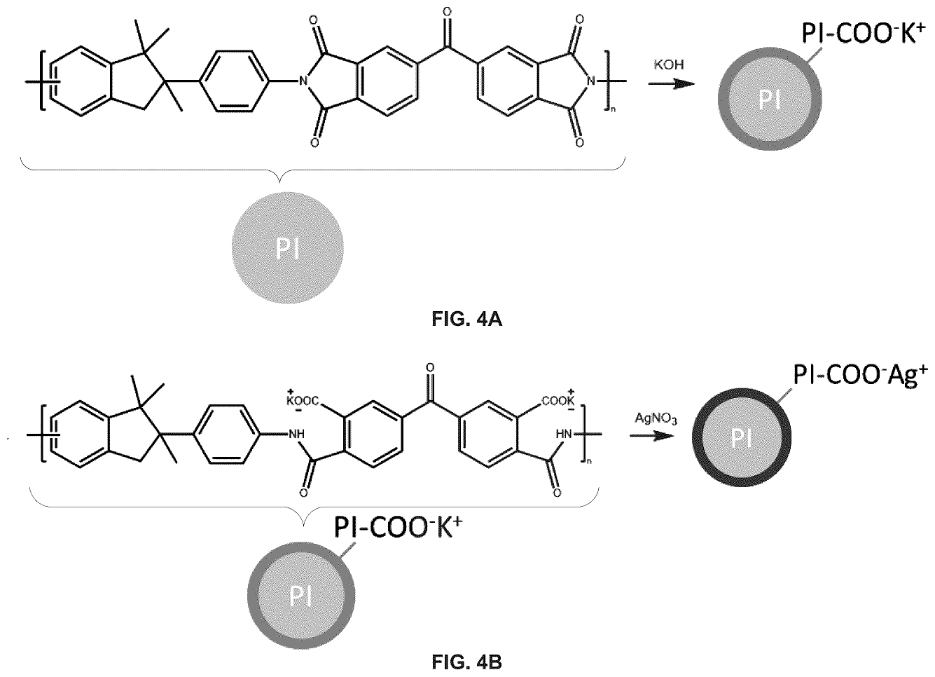

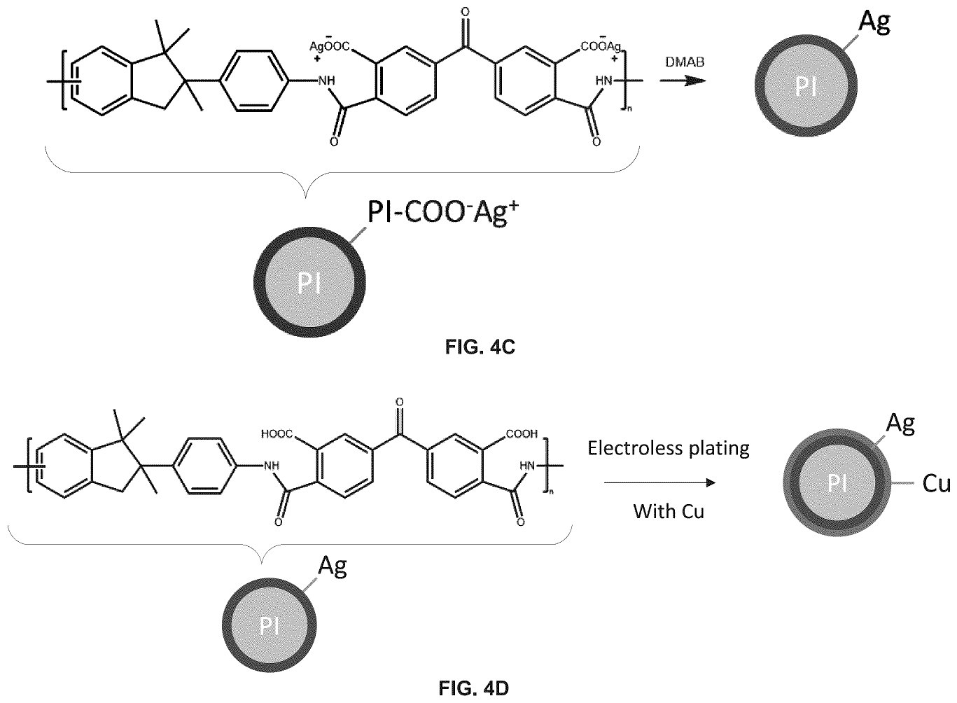

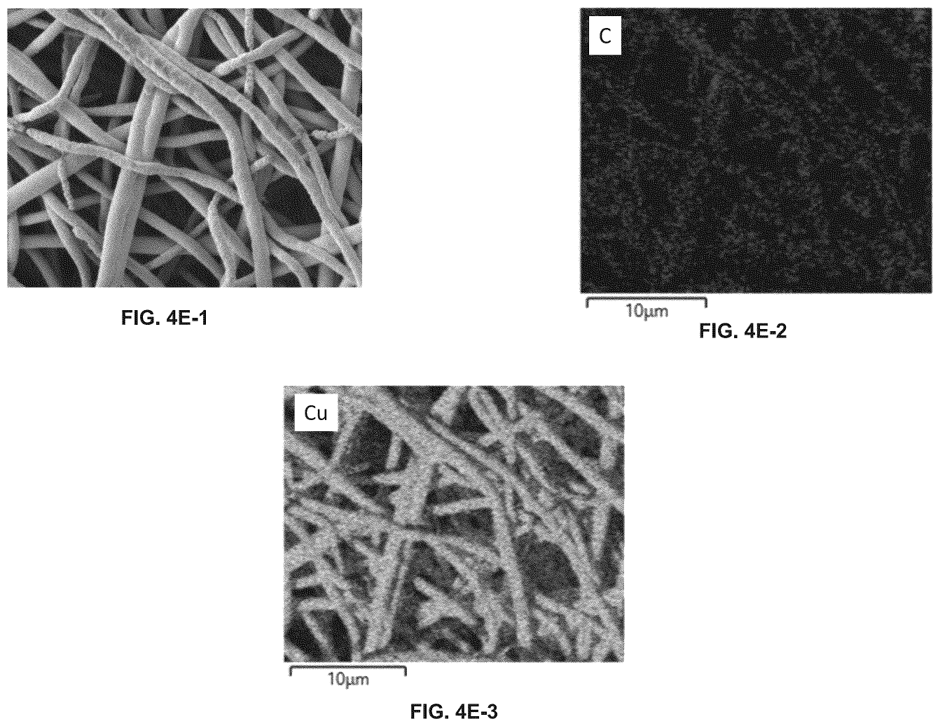

FIGS. 4A-4D illustrate a specific implementation of a process for forming a copper coated polymeric scaffold similar to that set forth in blocks 202, 203, 304, 305, and 208 of FIGS. 2-3 where a PI scaffold is prepared and receives a preliminary coating of Cu but is not yet heat-treated. FIG. 4A depicts PI being treated with KOH. FIG. 4B depicts the treated PI and attached K ions being treated with AgNO₃ to replace the K ions with Ag ions. FIG. 4C depicts PI nanomat with Ag ions being treated with dimethylamine borane (DMAB) to convert the Ag ions to Ag metal. FIG. 4D depicts the PI with seeds of Ag being electrolessly plated with Cu. to make the PI/Ag seeded material after receiving a preliminary coating of Cu in a schematic form. This coating may be considered pristine as it has not yet undergone heat treatment to modify its texture or to otherwise improve coating to make it more uniform and better connected and provide a scaffold structure that is capable of internally incorporating more anode metal within the openings in the PI scaffold structure than would be possible without the heat treatment.

A more detailed discussion of the formation of the Cu@PI nanomat is provided infra and involves the formation of a PI mat via electrospinning to achieve a thickness around 30 microns, then treating the PI to provide Cu nanoparticles (Pristine-Cu@PI) that generally do not form a smooth or uniformly connected Cu coating, and finally performing additional processing via a heat treatment to provide a connected and smoother Cu coating on the PI to a produce a useful Cu coated anode current collector (HT-Cu@PI) of appropriate thickness and uniformity to provide for effective acceptance of anode material within its openings via electrodeposition.

To check if the Cu nanoparticles were well-coated on PI nanofibers, SEM imaging and EDS mapping were conducted. It was found that the submicron-size Cu nanoparticles were uniformly distributed on the PI nanofibers as can be seen in the images of FIGS. 4E1-4E3. The SEM image of FIG. 4E-1 shows coated but bumpy PI fibers. The Cu particles forming the coating were detected via EDS mapping and are shown in the Cu view of FIG. 4E-3 while the exposed PI nanofibers were detected via EDS mapping and are shown in the C view of FIG. 4E-2.

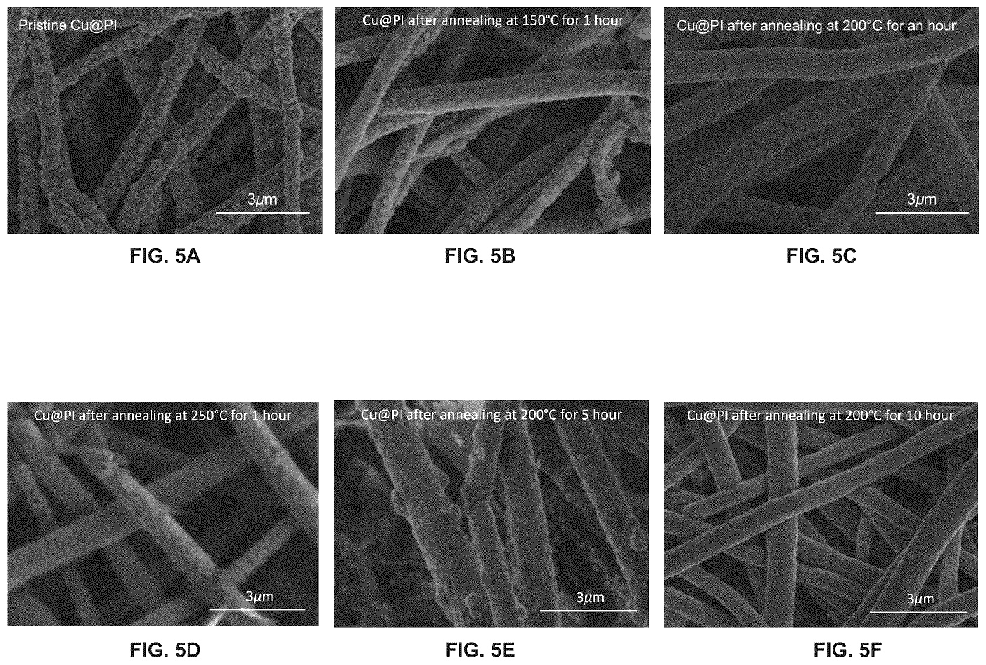

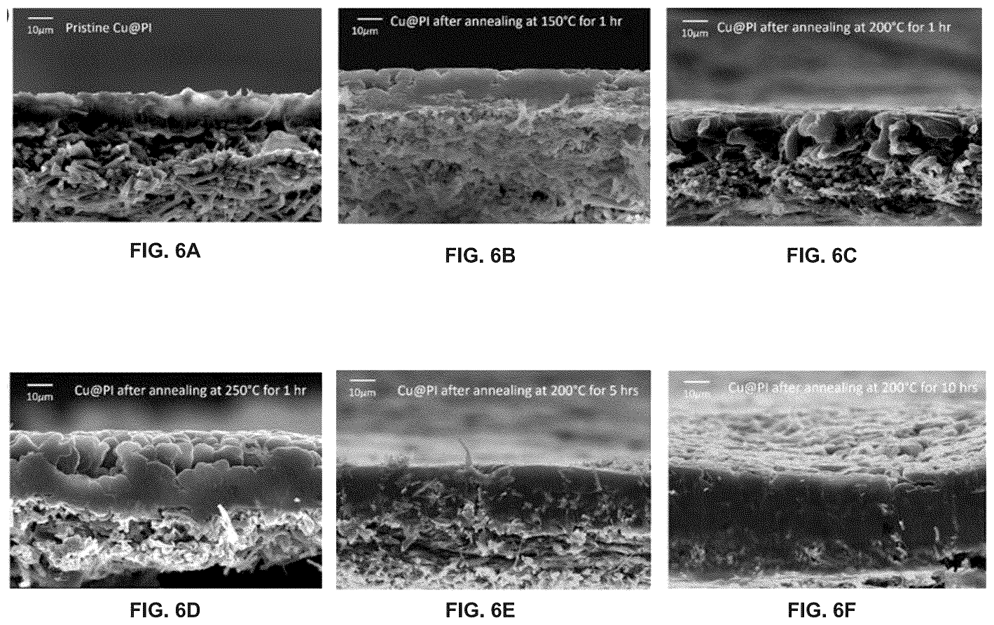

FIG. 5A provides an SEM image of a Cu coating on a nanomat that has not been subjected to heat treatment while FIGS. 5B-5F provide SEM images of Cu coated scaffolds that were subject to different heat treatment processes as example implementations of the operation of block 209 of FIG. 2. The heat treatment processes generally resulted in improvements to one or more of coating smoothness, coating thickness uniformity, electrical conductivity of the coating, and/or possibly the connectivity of the overall deposited Cu. FIG. 5A provides an SEM image showing a portion of a Cu coated scaffold after formation without heat treatment which may be referred to as pristine Cu on PI or pristine Cu@PI. This designation is not because the Cu coating is perfect but because it has not been subjected to additional processing. The roughness or non-uniformity of the coating can readily be seen in FIG. 5A with the diameter of the individual strands being in the range of about 0.5 μm to about 1 μm. FIGS. 5B-5F are shown at the same scale as FIG. 5A but where the deposited Cu (and scaffold) has been subjected to heat treatment at 150° C. for 1 hour (FIG. 5B), at 200° C. for 1 hour (FIG. 5C), at 250° C. for 1 hour (FIG. 5D), at 200° C. for 5 hours (FIG. 5E), and at 200° C. for 10 hours (FIG. 5F). The improvement in coating uniformity can be seen when comparing the untreated coating (FIG. 5A) to the treated coatings (FIGS. 5B-5F). Furthermore, an improvement in coating uniformity is also apparent as the temperature of the heat-treating process is increased (FIGS. 5B-5D). From a temperature perspective, 200° C. is considered more favorable than either 150° C. or 250° C. as it provides better coverage and as it subjects the nanomat to less risk of temperature damage (e.g., less possible shrinkage) and less risk of other potential adverse effects which could lead to reduced anode metal deposition (e.g., Li metal deposition) into the openings, pores, or voids in the scaffold. It is believed that in some embodiments, heat treatment at 250° C., or close to 250° C. may be acceptable though generally less preferred. It is also believed that in some embodiments heat treating at temperatures up to 300° C. may be acceptable. When using other nanomat materials such as polycarbonate, polysulfone, which may have melting temperatures different from PI, it is within the level of ordinary skill in the art to optimize the heat treatment temperature to optimize or otherwise achieve satisfactory heat treated coatings. In alternative embodiments, different nominal PI fiber diameters may be used that would provide the scaffold with different areal surfaces, porosity, and mechanical properties wherein thinner fibers may be weaker but provide higher volumes to accommodate Li and thicker fibers may provide better mechanical properties but allow smaller volumes to accommodate Li metal storage and movement. Based on the teachings herein, it will be apparent for those of skill in the art, without undue experimentation, to tweak fiber diameters and spacings while achieving functional results. Further improvements in the metal coatings (e.g. Cu) can be seen when extending the heat treatment time from 1 hour, to 5 hours, to 10 hours at 200° C. wherein improved surface uniformity is obtained. Though lower heat treatment temperatures and heat treatment times are less effective for promoting metal anode deposition in the openings, pores, or voids (e.g., Li penetration), they can lead to improved surface uniformity and thus may be useful in some embodiments. Heat treatment at 200° C. and for 10 hours provided the best overall results as evidenced in the discussion below with regard to FIGS. 6A-6F.

FIGS. 6A-6F provide side view SEM images of a Li anode material, loaded into/onto a Cu coated polymeric scaffold (PI in this example) where the Cu coated scaffolding was exposed to different heat treatments prior to Li loading to determine/confirm which heat treatment process provided the most Li penetration or loading into scaffold openings, pores, or voids. FIG. 6A shows a Li deposit over a scaffold that wasn't heat-treated where some Li loading occurred within the nanomat but with a great deal of deposition being on top of the nanomat. FIG. 6B shows a Li deposit onto and into a scaffold that was heat-treated at 150° C. for 1 hour. FIG. 6C shows a Li deposit onto and into a scaffold that was heat-treated at 200° C. for 1 hour. FIG. 6D shows a Li deposit onto and into a scaffold that was heat-treated at 250° C. for 1 hour. FIG. 6E shows a Li deposit onto and into a scaffold that was heat-treated at 200° C. for 5 hours while FIG. 6F shows a Li deposit onto and into a scaffold that was heat-treated at 200° C. for 10 hours. As can be seen in FIG. 6A some deposition of Li occurred within the pores of the scaffold but with the lower portion of the scaffold remaining distinctly visible. In FIGS. 6B, 6C, and 6D more penetration of the Li into the scaffold pores occurred. Even further Li penetration occurred when the scaffold was annealed at 200° C. for five hours (FIG. 6E) and even more complete filling occurred when heat treatment was applied for 10 hours (FIG. 6F). Though lower heat treatment temperatures and heat treatment times are less effective at allowing Li penetration they do provide some improvement and may be useful in some embodiments of the invention.

A specific exemplary process for forming a current collector according to one embodiment of the invention, includes:
Fabricating a PI nanomat via electrospinning with 20˜25 wt. % of PI powders (PolyK Matrimid 5218) dissolved in a mixture of N,N-dimethylformamide (DMF), and NMP (with 1:1 by wt. %) at 90° C. The prepared PI solution was subjected to electrospinning at 18˜20 kV with a feed rate of 0.75 mL h⁻¹ using an array of 17 G needles with a needle-to-needle distance of 12.7 mm, a needle-to-collector distance of 203 mm, and a collector rotation speed of 175 rpm. The relative humidity was controlled to be less than 20% during electrospinning. The resulting electrospun PI nanomat had a 30 μm nominal thickness.
The resultant PI nanomat was cut to size for coating with copper. The cut PI nanomat was initially etched with 0.01 M KOH in an ethanol solution for 48 hours to facilitate the ring opening of the imide to polyimide that included K ions (PI-COO—K⁺) (FIG. 4A).
After obtaining the PI-COO—K⁺the polymer was washed in deionized water (D.I. water) three times to remove the KOH and ethanol residue.
Subsequently, the PI-COO—K⁺was immersed in 0.1 M AgNO₃ aqueous solution for 30 minutes to substitute the K⁺ ions with ⁺ ions (PI-COO—Ag⁺) (FIG. 4B).
After obtaining the PI-COO-Ag⁺, the polymer was washed in D.I. water three times to remove the AgNO₃ residue.
Thereafter, the PI-COO—Ag⁺ was chemically reduced to Ag nanoparticles using a 1 mM dimethylamine borane (DMAB) aqueous solution to create an Ag seeded PI scaffold (Ag@PI) (FIG. 4C).
The Ag@PI composite material was subsequently immersed into an electroless plating solution of Cu ions (Caswell Inc, 855) for 20 minutes to coat Cu nanoparticles on the seeded PI nanofibers (FIG. 4D).
After this, the Cu@PI was heat-treated in an argon (Ar) atmosphere at various temperatures to smooth the coated Cu particles on the PI fibers and to further improve the electronic conductivity of the coated Cu on the PI fibers.

Variations of the above specific embodiment are possible whereby it is believed:
The polymeric nanomat or scaffold:
   i. may be formed of a dielectric material that is different from PI, such as for example polycarbonate or polysulfone. In still other embodiments, different polymer nanomats may be useful.
   ii. may be formed of a combination of two or more different polymers, such as for example PI, and polycarbonate and/or polysulfone.
   iii. may be formed using different process parameters and/or with different dimensions than those set forth above or hereafter.
The seeding with K ions:
   i. may be replaced with by seeding with a different material such as Na ions, Li ions.
   ii. may occur using a different process than that set forth above or hereafter.
In some in embodiments the replacement of K ions with Ag ions may be eliminated in favor of making the replacement using different ions.
In some embodiments the replacement of Ag ions with Ag metal nanoparticles, may be eliminated in favor of deposition of other materials.
The electroless deposition of Cu over the seeded scaffold:
   i. may be replaced with an alternative deposition process such as electrochemical deposition.
   ii. the deposition of Cu may be replaced by deposition of an alternative conductive material.
the heat treatment of the Cu coated scaffold:
   i. may occur for different times than those specifically set forth herein, such as for example heating time may vary from 1-24 hours, more preferably 2-15 hours, and most preferably between 5-10 hours.
   ii. may occur at different temperatures than those specially set forth herein, such as for example between 100 and 300° C., more preferably between 150 and 250° C., and most preferably between 175-225° C.
   iii. may occur by varying or oscillating between different temperatures over fixed or varying time periods.
   iv. may occur in the presence of different inert gases such as, for example nitrogen.

In some implementations, the nanomat may have an area that is selected for a given battery or cell configuration wherein the area is defined as being substantially perpendicular to a direction of current flow between an anode and a cathode. The nanomat may also have a thickness that is defined as being substantially parallel to a direction of current flow between an anode and a cathode or perpendicular to the area. The nominal thickness, for example, may be on the order of tens of microns, e.g., 1 to 100 μm or more and is preferably between 5-50 μm and even more preferably between 10-30 μm. The individual nanofibers may have their lengths extending substantially along the plane or areal region of the mat (i.e., substantially perpendicular to the thickness of the mat with some variation for strands to crossover and overlay one another) and have variety of widths or nominal diameters (perpendicular to their lengths) that may be on the order of 0.1 to 10 μm, preferably 0.25 to 5 μm, and more preferably 0.5 to 2 μm, with gaps between neighboring strands are generally 1-5 times their diameters to form pockets or openings that can receive and provide anode material via electrochemical deposition and removal. The Cu plating over the polymer scaffold may, for example, have a thickness on the order of tens of nanometers, e.g., less than 1000 nm but more than 1 nm, more preferably less than 200 nm but more than 5 nm, and even more preferably less than 100 nm but more than 10 nm. As used herein, “nominal” or “nominally” refers to thickness, areas, lengths, diameters and the like where natural variations in these parameters exist and it is intended that a majority of the features fall within the indicated nominal ranges. For example, a majority of the length of a majority of the nanofibers will have diameters that fall within the indicated ranges. Openings or spacing between crossing fibers range from zero at the cross-over points but extend to larger spacing as separation occurs such that the openings have a nominal width or length based on an average separation distance where a majority of the spacings will have their averaged size within a nominal range.

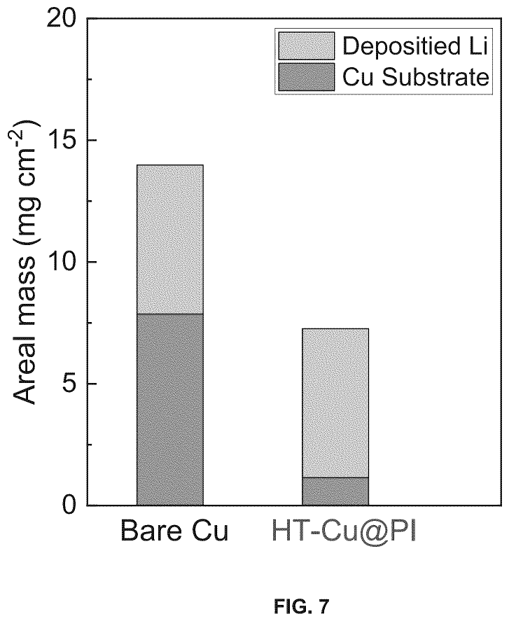

While a 30 micron PI nanomat was used as a scaffold for the Cu@PI anode current collector for experiments herein, a 12-μm thick commercial 2D Cu foil was used as a control substrate (i.e. as the substrate for the bare-Cu anode). The HT-Cu@PI substrate is a significantly lighter substrate (by weight) compared to the Bare Cu substrate. The HT-Cu@PI substrate can allow more Li metal to be stored for a fixed weight of electrodes and provide a smaller volume change (i.e., change in height between charged and discharged states). The mass of HT-Cu@PI is only 14.5% of the bare Cu. When 5 mAh cm⁻² of Li is deposited on the two substrate types, the EDLi-Bare Cu weights 13.98 mg cm⁻² (Li: 6.12 mg cm⁻² and Bare Cu: 7.86 mg cm⁻²) with a 43.7 wt. % portion of Li. The weight of EDLi-HT-Cu@PI with the same amount of Li is 7.26 mg cm⁻² (Li: 6.12 mg cm⁻² and Cu@PI: 1.14 mg cm⁻²) with an 84.3 wt. % portion of Li. Thus the Li portion with an HT-Cu@PI substrate is much greater. FIG. 7 provides a plot showing the areal mass of Cu versus deposited Li associated with a Bare Cu substrate and with an HT-Cu@PI scaffold substrate. It can be seen from the above data and these plots that more than 55% of the area mass of the bare Cu anode is from the Cu substrate while less than 15% is from the HT-Cu@PI substrate.

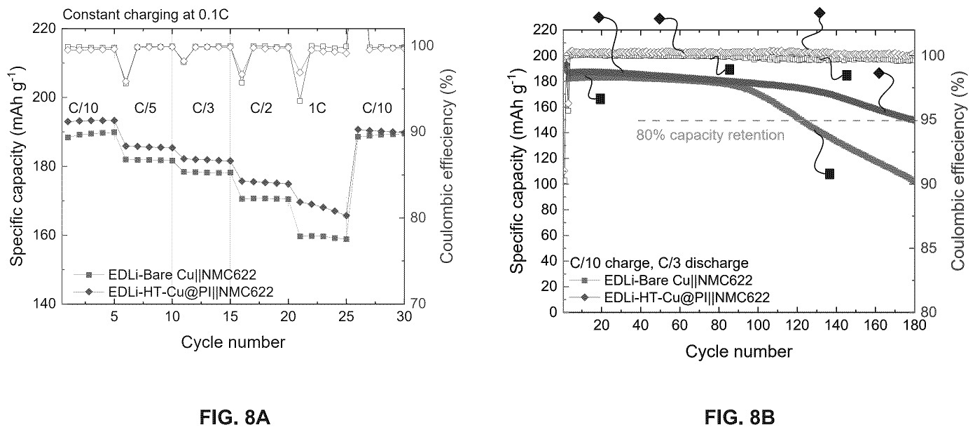

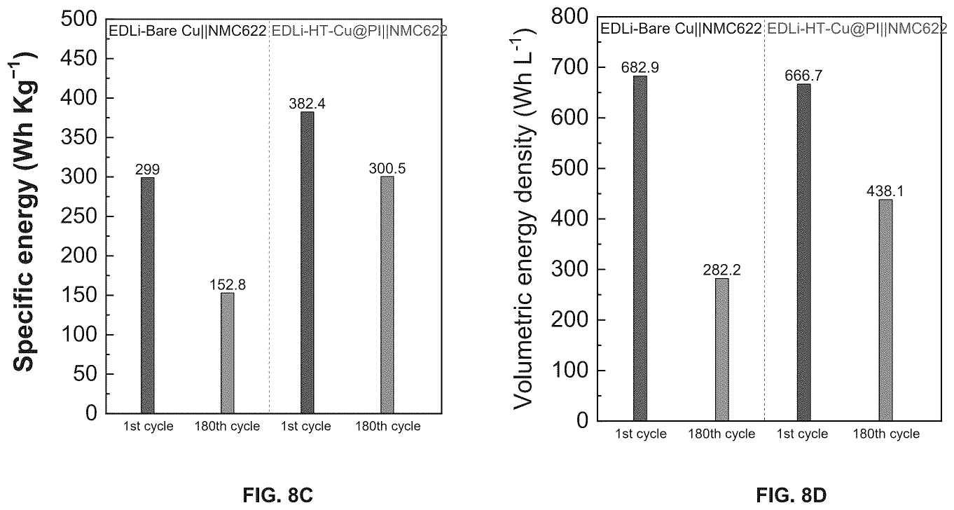

To check the electrochemical performance of the current collectors, battery cells were formed. A 16 mm diameter, 10-hour 200° C. heat-treated, Cu coated scaffold collector was loaded with EDLi to a capacity of 5 mAh cm⁻². The loading was performed at a current density of 0.5 mA cm⁻² using 75 μL of the electrolyte made of lithium bis(fluorosulfonyl)imide (LIFSI, battery grade, Nippon Shokubai), 1,2-dimethoxyethane(DME, battery grade, Gotion, Inc.), and 1,1,2,2-tetrafluoroethyl- 2,2,3,3-tetrafluorpropyl ether (TTE, 99%, SynQuest), at 1.0:1.2:3.0 by mol. After Li deposition, the loaded scaffold was assembled with a LiNi_{0.6}Mn_{0.2}Co_{0.2}O_{0.2} (NMC622, 12.7 mm diameter—4.5 mAh cm⁻²) cathode electrode, 75 μL of the electrolyte (LIFSI:DME:TTE at 1.0:1.2:3.0 by mol), and with a 20 μm thick polyethylene separator. CR2032 coin cell kits (MTI Corporation) with aluminum (Al)-clad positive cases were used with an additional piece of Al foil (19.0 mm diameter) to prevent electrolyte corrosion of the stainless-steel positive case to assemble the testing cells in an argon-filled glovebox (MBraun, moisture and oxygen content ≤0.1 ppm). The NMC622 electrode was 96 wt. % NMC622, 2 wt. % of carbon black, and 2 wt. % polyvinylidene fluoride (PVdF) binder. The cells underwent a formation step of two charge/discharge cycles at C/10 (where 1C=4.5 mA cm⁻²) in the voltage range of 2.8-4.4 V at 25° C. After that discharge rate capability and cycle performance tests were performed using a Landt tester. For the discharge rate capability test, a constant current density of C/10 was used for charging and the discharging current densities were at C/10, C/5, C/3, C/2, 1C, and C/10 for 5 cycles at each discharging rate. The EDLi-Cu@PI||NMC622 cells were cycled at C/10 charging and C/3 discharging to determine battery life. The galvanostatic intermittent titration technique (GITT) profiles were obtained using a potentiostat/galvanostat (VSP classic, BioLogic). A 12 μm two-dimensional (2D) Cu foil (Bare Cu) was used as a current collector under the same conditions as the scaffolded collector as a control for comparison. FIG. 8A compares the discharge rate capability of the cells with the scaffolded collectors and those with bare Cu collectors. The cells with scaffolded collectors delivered a higher capacity of 193 mAh g⁻¹ at a current density of C/10 for discharging than those with bare Cu (188 mAh g⁻¹). The cells with scaffolded substrates demonstrated increased discharge capacities even at 1C discharge rate (170 mAh g⁻¹ compared to those with bare Cu (160 mAh g⁻¹)).

The graph of FIG. 8B provides the results of a long-term cyclability test of the cells with scaffolded collectors and those with bare Cu. The initial capacities of the cells with bare Cu and HT-Cu@PI at C/10 for charging and at C/3 for discharging were 182.0 mAh g⁻¹ and 186.7 mAh g^{-1,} respectively. This result indicates that the reduced internal resistance of HT-Cu@PI cells leads to higher capacity by more Li utilization in the 3D or scaffolded substrate than in the 2D or bare Cu foil. 80% of capacity retention was reached with the cell having bare Cu collectors at 126 cycles while those with the heat-treated scaffolds made it to 180 cycles. The data for EDLi-Bare Cu is identified with rectangles while the data for EDLi-HT-Cu@PI is identified with diamonds.

As opposed to the plots of areal mass versus substrate type shown in FIG. 7, FIG. 8B provides plots of specific capacity and coulombic efficiency versus cycle number for an EDLi bare-Cu substrate and an EDLi-HT-Cu-PI substrate when the total mass of a cell stake (including cathode/Al substrate, separator, EDLi/substrate Cu or HT-Cu@PI)) is used to calculate the specific energy of EDLi||NMC622 cells, the cell with HT-Cu@PI shows higher specific energy (382.4 Wh kg⁻¹) than that with bare Cu (299.0 Wh kg⁻¹) at the first cycle and continues to show a significant advantage at even 180 cycles.

FIG. 8C provides plots of specific energy for an EdLi-Bare Cu||NMC822 dry cell stake and an EDLi-HT-Cu@PI||NMC822 cell stake at first cycle and at 180th cycles illustrating the improvement in specific energy initially and after long cycling provided by the HT-Cu@PI anode current collector. Benefitting from the structural advantage of HT-Cu@PI, even after 180 cycles, the cells with HT-Cu@PI still deliver a specific energy of 300.5 Wh kg⁻¹, nearly twice that of the cells with bare Cu (152.8 Wh kg⁻¹). FIG. 8D provides energy density plots for an EdLi-Bare Cu||NMC822 cell stake and an EDLi-HT-Cu@PI||NMC822 cell stake at first cycle and at a 180th cycles illustrating the improvement in energy density after long cycling provided by the HT-Cu@PI anode current collector. These results indicate that an LMB using a lighter 3D current collector made of Cu-coated polymeric nanomat could improve both the cyclability and energy density of such batteries as compared to similar batteries using 2D Cu foil as the anode current collector.

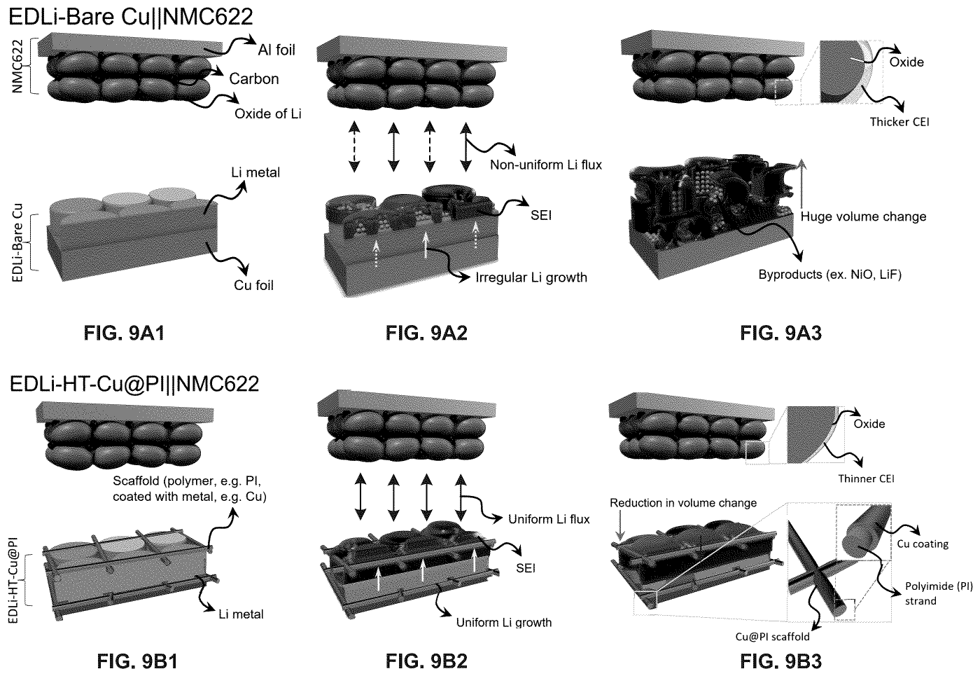

FIGS. 9A1-9A3 provide schematic illustrations for Li loading and unloading, between a collector for a NMC622 cathode and a Cu foil collector (EDLI-Bare Cu) for an anode of the prior art. FIGS. 9B1-9B3 provide schematic illustrations for a current collector of an NMC622 cathode and a heat-treated Cu coated dielectric scaffold current collector (EDLi-HT-Cu@PI) for an anode of an embodiment of the present invention. These schematic illustrations set forth some mechanisms that may be involved in poorer performance of the EDLI-Bar Cu anodes and improved Li loading and battery performance resulting from the improved current collector structure for the EDLi-HT-Cu@PI anode of embodiments of the present invention. In FIGS. 9A1-8A3 a bare Al current collector for a cathode in combination with a bare Cu foil current collector for an anode (FIG. 9A1) can result in non-uniform Li ion flux (FIG. 9A2), irregular Li growth (FIG. 9A3), thicker cathode-electrolyte interphase (CEI) on cathode (upper portion of FIG. 9A3), and thicker solid electrolyte interface (SEI) with resulting byproducts (e.g., NiO and LiF) on anode (lower portion of FIG. 9A3). While the improved collectors of some embodiments of the invention provide more uniform Li ion flux (FIG. 9B2), uniform Li growth (lower portion of FIG. 9B2), thinner CEI on cathode (upper portion of FIG. 9B3) and thinner SEI with reduced volume change at the anode (lower portion of FIG. 9B3) with the expanded portion of FIG. 9B3 showing Cu coating PI strands to provide improved electron flow.

### ADDITIONAL REMARKS

Any materials referenced herein are incorporated herein by reference as if set forth in full. The order of preference in applying differing teachings or definitions that may be set forth herein will be: (1) Definitions or other teachings set forth herein directly (i.e. not incorporated-by-reference), (2) Definitions or other teachings set forth in a parent application, (3) Definitions or other teachings set forth in appendices of a parent application, and (4) definitions or other teachings set forth in materials otherwise incorporated herein by reference wherein incorporated materials having more recent dates given precedence over incorporated materials having older dates.

It is intended that the aspects of the invention set forth specifically herein or otherwise ascertained from the present teachings represent independent invention descriptions which Applicant contemplates as full and complete, and that Applicant believes may be set forth as independent claims without need of importing additional limitations or elements from other embodiments or aspects set forth herein for interpretation or clarification. It is also understood that any aspects and variations of the aspects (as well as embodiments and their variations) set forth herein represent individually or in groups features that may form separate independent claims, be individually added to independent claims, or added as dependent claims to further define an invention.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. Forming a current collector for a metal anode, comprising:
a) providing an electrospun dielectric polymer scaffold formed from crossed strands of polymer with openings between strands of the polymer;
b) etching the scaffold to introduce potassium ions;
c) replacing the potassium ions with silver ions;
d) modifying the scaffold to replace silver ions with silver nanoparticles;
e) depositing copper onto the scaffold having the silver nanoparticles; and
f) heat-treating the copper plated scaffold at a selected temperature and time that is effective in reducing roughness of deposited copper while not damaging the polymer scaffolding to yield a polymer structure that is more capable of repeatedly receiving and holding an active metal anode material within its openings and discharging such metal anode material than it would have been without the heat treatment.

2. The method of claim 1 additionally comprising embedding the active anode metal into the openings in the heat treated, copper coated, dielectric polymer scaffold to form an anode for a metal battery;
wherein the active anode metal comprises lithium;
wherein the polymer comprises a polymer selected from the group consisting of: (a) polyimide, (b) polycarbonate, (c) polysulfone, and (d) a combination of two or more of the polymers of (a)-(c);
wherein the scaffold has an area and wherein the scaffold has a nominal thickness for at least a portion of the area and wherein the nominal thickness is selected from the group consisting of: (a) between 1 and 100 microns inclusive, (b) between 5 and 50 microns inclusive, and (c) between 10-30 microns inclusive;
wherein a majority of the strands of the polymer have nominal diameters selected from the group consisting of: (1) between 0.1 micron to 10 microns, (2) 0.5 micron and 2 microns; and
wherein a majority of the openings between the strands have a width and length in a plane perpendicular to a thickness of the scaffold that are nominally in the range of 1 to 5 times the diameter of the strands.

3. The method claim 1 wherein the etching comprises use of a solution of potassium hydroxide in ethanol;
wherein the replacing comprises immersing the scaffold in a solution of silver nitrate;
wherein the modifying comprises use of an aqueous solution.
wherein the depositing comprises electrolessly depositing copper.
wherein the heat-treating comprises exposing the scaffold for a time period of at least one hour to a temperature selected from the group consisting of at least one of: (a) a temperature between 100° C. to 300° C., (b) a temperature between 150° C. to 250° C., and (c) a temperature between 175° C. to 225° C.; and.
wherein the time period is selected from the group consisting of: (a) at least 2 hours, (b) at least 4 hours, and (c) at least 8 hours.

4. A current collector for a metal anode, comprising:
a) a nonwoven polymeric scaffold comprising strands of dielectric polymer with each strand having a surface and wherein the scaffold has openings located between the strands;
b) metal nanoparticle material seeds located on the surfaces of the strands of the scaffold, and;
c) copper overcoating the metal nanoparticle material seeds to define a copper coated scaffold wherein the copper provides a continuous conductive surface over the surface of the metal seeded scaffold and wherein openings remain between the copper coated strands for receiving an anode metal.

5. The collector of claim 4 wherein an anode metal at least partially fills the openings of the scaffold.

6. The collector of claim 5 wherein the anode metal comprises lithium.

7. The collector of claim 4 wherein the polymer comprises a polymer selected from the group consisting of: (a) polyimide, (b) polycarbonate, and (c) polysulfone.

8. The collector of claim 7 wherein the scaffold has a nominal thickness for at least part of its area selected from the group consisting of: (a) between 1 micron and 100 microns, (b) between 5-50 microns, and (c) between 10-30 microns.

9. The collector of claim 8 wherein a majority of the strands of the polymer have nominal diameters selected from the group consisting of: (a) between 0.1 micron and 10 microns, (b) 0.5 micron and 2 microns.

10. The collector of claim 9 wherein the nanoparticle seed material comprises silver.

11. The collector of claim 10 wherein the copper has nominal thickness selected from a first group consisting of: (a) between 1 and 1000 nanometers, (b) between 5 and 200 nanometers, and (c) between 10 and 100 nanometers.

12. A metal battery, comprising:
a) a scaffolded anode current collector for an anode comprising a nanomat of polymeric dielectric strands seeded with a first metal and covered with a second metal, wherein openings are located between the covered strands, wherein an anode metal is located at least partially into the openings, and wherein the second metal is different from the first metal and is also different from the anode metal;
b) a cathode including a current collector;
c) an electrolyte for conducting metal ions between the anode and the cathode;
d) a separator located between the anode and the cathode; and
e) a case for holding the anode, the cathode, the electrolyte, and the separator.

13. The metal battery of claim 12 wherein the metal anode material comprises lithium and the metal battery comprises an LMB.

14. The metal battery of claim 12 wherein the polymeric material comprises a polymer selected from the group consisting of: (a) polyimide, (b) polycarbonate, and (c) polysulfone.

15. The metal battery of claim 12 wherein the scaffold has a nominal thickness for at least part of its area selected from the group consisting of: (1) between 1 micron and 100 microns, (2) between 5-50 microns, and (3) between 10-30 microns.

16. The metal battery of claim 12 wherein a majority of the strands of the polymer have nominal diameters selected from the group consisting of: (a) between 0.1 micron and 10 microns, (b) between 0.5 micron and 2 microns.

17. The metal battery of claim 12 wherein the second metal comprises copper and has nominal thickness selected from a group consisting of: (a) between 1 and 1000 nanometers, (b) between 5-200 nanometers, and (c) between 10-100 nanometers.

18. An anode-free metal battery, comprising:
a) a scaffolded anode current collector for an anode comprising a nanomat of polymeric dielectric strands seeded with a first metal and covered with a second metal, wherein openings are located between the covered strands, and wherein the second metal is different from the first metal;
b) a cathode including a current collector;
c) an electrolyte for conducting metal ions between the scaffolded anode current collector and the cathode;
d) a separator located between the cathode and the anode current collector; and
e) a case for holding the cathode, the anode current collector, the separator, and the electrolyte.

19. The anode-free metal battery of claim 18 wherein the cathode comprises active ions of a metal selected from the group consisting of: (a) lithium, (b) sodium, and (c) potassium which provide functionality selected respectively from the group consisting of: (a) anode-free lithium metal battery functionality, (b) anode-free sodium metal battery functionality and (c) anode-free potassium metal battery functionality.

20. The anode-free metal battery of claim 18 wherein the polymeric material comprises a polymer selected from the group consisting of: (a) polyimide, (b) polycarbonate, and (c) polysulfone.

21. The anode-free metal battery of claim 18 wherein the scaffold has a nominal thickness for at least part of its area selected from the group consisting of:
(a) between 1 micron and 100 microns, (b) between 5-50 microns, and (c) between 10-30 microns.

22. The anode-free metal battery of claim 18 wherein a majority of the strands of the polymer have nominal diameters selected from the group consisting of:
(a) between 0.1 micron and 10 microns, (b) between 0.5 micron and 2 microns.

23. The anode-free metal battery of claim 18 wherein second metal comprises copper and has nominal thickness selected from a group consisting of: (a) between 1 and 1000 nanometers, (b) between 5-200 nanometers, and (c) between 10-100 nanometers.
